(19) United States
(12) Patent Application Publication
(10) Pub. No.: US 2009/0025671 A1
(43) Pub. Date: Jan. 29, 2009

(54) Air Intake System of a Multi-Cylinder Internal Combustion Engine

(75) Inventors: Thomas Rauner, Blaubeuren (DE); Bjorn Muller, Altenstadt (DE); Rico Fischer, Vaihingen/Enz (DE); Erwin Rutschmann, Tiefenbronn (DE)

Correspondence Address: LERNER GREENBERG STEMER LLP, P O BOX 2480, HOLLYWOOD, FL, 33022-2480, US

(73) Assignee: DR. ING. H.C. F. PORSCHE AG, Weissach (DE)

(21) Appl. No.: 12/179,105

(22) Filed: Jul. 24, 2008

(30) Foreign Application Priority Data
Jul. 24, 2007 (DE) 10 2007 034 515.3

(51) Int. Cl. F02M 35/10; F02M 35/024

(52) U.S. Cl. 123/184.21; 123/198 E

(57) ABSTRACT

An air intake system of a multi-cylinder internal combustion engine has a first collecting chamber and a second collecting chamber. An inflow line supplies intake air to the first collecting chamber. First regions of a plurality of ram pipes are connected to the first collecting chamber and guided through the second collecting chamber and opening out into second regions of the ram pipes. The second regions are arranged outside of and connected to the second collecting chamber. The first regions of the ram pipes are arranged within the second collecting chamber and have adjustable sections. When the adjustable sections of the intake pipes are in one position, intake air is sucked in directly through the first and second regions of the ram pipes. When they are in a second position, intake air is sucked into the second collecting chamber and from the latter into the second regions of the ram pipes. An overflow chamber device connects the first collecting chamber and the second collecting chamber to one another. The overflow chamber device forms an additional overflow volume between the two collecting chambers, to provide increased air mass throughput in the power position, that is, in the second position of the adjustable sections of the ram pipes.

### CROSS-REFERENCE TO RELATED APPLICATION

This application claims the priority, under 35 U.S.C. § 119, of German application DE 10 2007 034 515.3, filed Jul. 24, 2007; the prior application is herewith incorporated by reference in its entirety.

### BACKGROUND OF THE INVENTION

1. Field of the Invention

The invention relates to an air intake system of a multi-cylinder internal combustion engine.

Air intake systems of multi-cylinder internal combustion engine are known which make use of ram pipes, through which intake air is sucked into the cylinders of the internal combustion engine. By means of the ram pipes, it is possible to influence the charge of the cylinder substantially by means of the gas-dynamic processes in the intake pipes. By means of said processes, it is possible under the operating conditions of the internal combustion engine to obtain a good cylinder charge, and therefore an extremely high torque of the internal combustion engine, in relatively low and middle rotational speed ranges of the internal combustion engine. In contrast, in a relatively high rotational speed range of the internal combustion engine, in which high power of the internal combustion engine is required, an increased air mass throughput is necessary, and consequently the air supply through the ram pipes is not optimal.

Commonly assigned German patent DE 43 15 129 C2, corresponding to U.S. Pat. No. 5,406,913, describes an air intake system of a multi-cylinder, two-row internal combustion engine. The cylinders of one row are connected in each case to one of two resonance tanks. Provided between the resonance tanks is a connecting pipe stub with a fresh air inlet. Ram pipes run in sections within the resonance tank and have adjustable sections, such that when the adjustable sections of the ram pipes are in a first position, intake air is sucked directly through the ram pipes into the cylinders of the internal combustion engine, and when the adjustable sections of the ram pipes are in a second position, intake air is sucked out of the resonance tank via an annular gap formed between the respective ram pipe end and the chamber wall. For this purpose, the air intake system is additionally provided with a two-chamber resonance system which has a further fresh air inlet and which is connected to the resonance tanks. Therefore, at relatively low rotational speeds at which no annular gaps are formed, a high torque is obtained by means of long ram pipes and a relatively small overall volume of the air intake system. On account of the decoupling of the resonance tank, sucked-in fresh air passes exclusively via the fresh-air inlet and the activated ram pipes into the cylinders of the internal combustion engine. When a relatively high rotational speed range is reached, the second of the ram pipes are adjusted. Sucked-in fresh air now passes, with the interposition of the resonance tank, both via the ram pipes and also via the two-chamber resonance system into the cylinders.

An air intake system of a multi-cylinder internal combustion engine in which long and short ram pipes can be realized as a function of parameters of the internal combustion engine is known from the commonly assigned German published patent application DE 199 03 123 A1 and its counterpart U.S. Pat. No. 6,357,410 B1.

Air intake systems for multi-cylinder internal combustion engines are also described in the following patent publications: DE 34 08 899 A1, DE 34 24 433 A1 (cf. U.S. Pat. No. 4,622,926), DE 198 41 810 A1, DE 199 15 819 A1, DE 10 26 358 B4 and DE 10 2004 015 339 A1 (cf. U.S. Patent Application Publication No. US 2007/0137603 A1).

### SUMMARY OF THE INVENTION

It is accordingly an object of the invention to provide an air intake system for a multi-cylinder internal combustion engine, which overcomes the above-mentioned disadvantages of the heretofore-known devices and methods of this general type and which improves an air intake system in such a way that a particularly high air mass throughput is ensured in the power position of the internal combustion engine.

With the foregoing and other objects in view there is provided, in accordance with the invention, an air intake system of a multi-cylinder internal combustion engine, comprising:
a first collecting chamber and a second collecting chamber;
an inflow line for supplying intake air to said first collecting chamber;
a plurality of ram pipes having first regions connected to said first collecting chamber, projecting through said second collecting chamber, and opening out into second regions disposed outside of and connected to said second collecting chamber;
said first regions of said ram pipes having adjustable sections disposed within said second collecting chamber and movable between a first position and a second position, wherein:
   when said adjustable sections of said ram pipes are in the first position, intake air is aspirated directly through said first and second regions of said ram pipes; and
   when said adjustable sections of said ram pipes are in the second position, intake air is aspirated into said second collecting chamber and, from there, into said second regions of said ram pipes; and
an additional overflow chamber device disposed to connect said first collecting chamber with said second collecting chamber.

In other words, the objects of the invention are achieved by means of an air intake system of a multi-cylinder internal combustion engine, having a first collecting chamber and having a second collecting chamber, having an inflow line for supplying intake air to the first collecting chamber, and having a plurality of ram pipes, with first regions of the ram pipes being connected to the first collecting chamber and being guided through the second collecting chamber and opening out into second regions of the ram pipes, which second regions are arranged outside and are connected to the second collecting chamber, with the first regions of the ram pipes having adjustable sections, which are arranged within the second collecting chamber, such that, when the adjustable sections of the intake pipes are in a first position, intake air is sucked in directly through the first and second regions of the ram pipes, and when the adjustable sections of the ram pipes are in a second position, intake air is sucked into the second collecting chamber and from the latter into the second regions of the ram pipes, and also having an additional overflow chamber device which connects the first collecting chamber and the second collecting chamber to one another.

In the air intake system according to the invention, the first collecting chamber performs the function of a torque collecting chamber and the second chamber performs the function of a power collecting chamber. When the adjustable sections are in the first position, the two regions suck in only the intake air which is then supplied directly to the cylinders of the internal combustion engine. Said ram pipe charging takes place in particular in the lower and middle rotational speed range of the internal combustion engine, with the purpose of optimizing torque. In contrast, in the power position of the internal combustion engine, in particular in the upper rotational speed range of the internal combustion engine in which the adjustable sections of the first regions of the ram pipes are in their second position, it is possible for the second regions of the ram pipes to suck directly from the overall volume of the second collecting chamber, wherein on account of the special design of the air intake system with the additional overflow chamber device, intake air flows into the second collecting chamber not only through said second regions of the ram pipes but also via the overflow chamber device. Said additional overflow chamber device is in particular a wide duct with a large cross section, such that in the power position of the internal combustion engine, the intake air passes from the first collecting chamber into the second collecting chamber primarily via the overflow chamber device.

In the intake system according to the invention, the cylinders of the internal combustion engine can, in the power position of the internal combustion engine, suck intake air via the second regions of the ram pipes directly from the second collecting chamber, which, on account of the large cross section of the overflow chamber device between the first collecting chamber and the second collecting chamber, can suck a sufficient quantity of intake air from the first collecting chamber.

The internal combustion engine has in particular six cylinders. The number of ram pipes preferably corresponds to the number of cylinders; six ram pipes are therefore provided in an internal combustion engine with six cylinders. It is however entirely conceivable for the number of cylinders of the internal combustion engine to be selected to be different from the number of ram pipes. For example, in a 6-cylinder internal combustion engine, it is possible for only three ram pipes to be provided. One ram pipe opens out into two cylinders.

According to one particular embodiment of the invention, it is provided that the overflow chamber device is formed in the manner of a hood. Said overflow chamber device is arranged in the upper region of the intake system and is preferably matched to the contour of the body of the vehicle, in particular of a passenger motor vehicle. Here, the air intake system is situated in particular in a front engine bay of a passenger motor vehicle. In this case, one preferred embodiment of the air intake system provides that the overflow chamber device is designed so as to widen in the longitudinal direction of the two collecting chambers, in particular so as to rise rearward with respect to the arrangement of the intake system in a front engine bay of a passenger motor vehicle. On account of said rising design of the overflow chamber device, the upper contour of the latter can substantially follow the contour of an engine hood of the passenger motor vehicle, such that sufficient pedestrian impact protection is ensured in this way.

In this context, it is considered to be particularly advantageous if the overflow chamber device is arranged asymmetrically with respect to an axis of symmetry arranged transversely with respect to the longitudinal extent of the two collecting chambers, in particular in the central and rear region of the collecting chambers with respect to the arrangement of the air intake system in a front engine bay of a passenger motor vehicle. As a result of said arrangement of the overflow chamber device, which is not arranged in the front region of the intake system but is positioned only in a region situated further rearward and is designed so as to rise rearward from there, the pedestrian impact protection below the engine hood of the passenger motor vehicle can be optimized further.

The inflow line for supplying intake air to the first chamber can be connected to the first collecting chamber at different points. It is considered to be preferable if the inflow line opens out into the first collecting chamber in the longitudinal direction of the latter, or opens out obliquely into the first collecting chamber in a longitudinal-side end region of the latter, on that side of the first collecting chamber which faces away from the ram pipes. In said designs, in particular the oblique arrangements of the inflow line, the intake air can flow into the first collecting chamber in a particularly flow-enhanced fashion. It is provided in particular that the inflow line is provided, in the region of the first collecting chamber, with a throughflow regulator, in particular a throttle flap.

The additional overflow chamber device makes it possible, with corresponding tuning of the inflow line to the first collecting chamber and of the first collecting chamber, for a large air mass flow to be passed through the air intake system. Accordingly, it is necessary to filter a large quantity of air per unit of time. From this aspect, one advantageous refinement of the invention provides that the inflow line for supplying intake air to the first collecting chamber has two air filters, with the one air filter being arranged on that side of the second chamber which faces away from the first collecting chamber, and with the other air filter being arranged on that side of the first collecting chamber which faces away from the second collecting chamber. When using two air filters, it is considered to be advantageous if the clean air from the first air filter is sucked in through a section of the inflow line which is connected to the clean-air side of the second air filter.

Other features which are considered as characteristic for the invention are set forth in the appended claims.

Although the invention is illustrated and described herein as embodied in air intake system of a multi-cylinder internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of the air intake system according to the invention;

FIG. 2 is a perspective view of the air intake system of FIG. 1, with upper sections of the collecting chambers removed;

FIG. 3 is a perspective view from below of the upper sections of the collecting chambers, and of the overflow chamber device which is connected to the upper sections;

FIG. 4 is a diagrammatic illustration of components which interact with the air intake system;

FIG. 5 is a diagrammatic view of a modification of the components which interact with the air intake system;

FIG. 6 is a perspective view of the air filter which is used in the modification as per FIG. 5 and which is arranged in the inflow region of the first chamber, illustrated in a first functional position of the air filter; and

FIG. 7 is a similar view of the air filter of FIG. 6 in a second functional position.

### DETAILED DESCRIPTION OF THE INVENTION

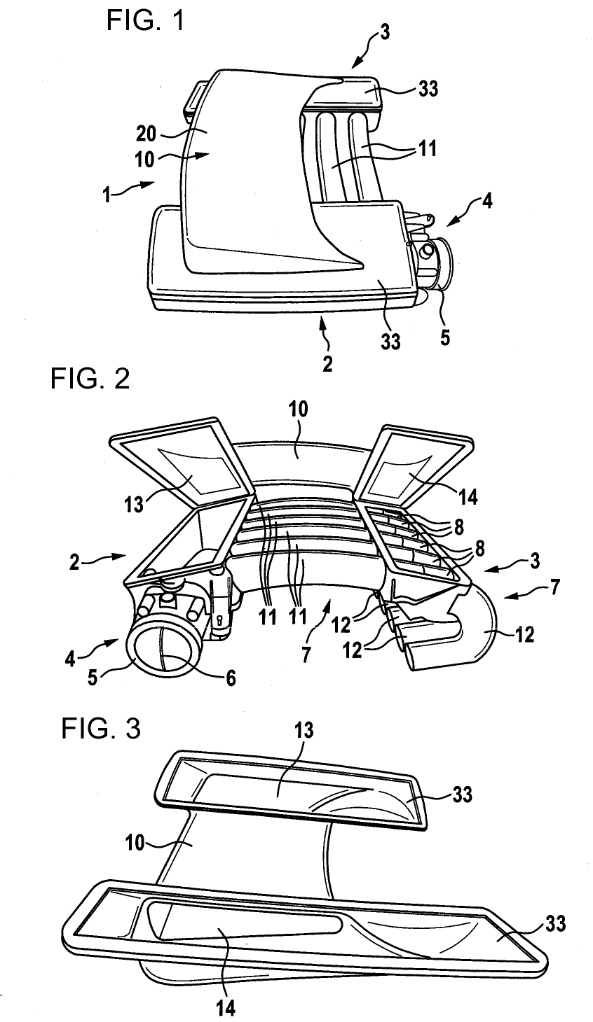

Referring now to the figures of the drawing in detail, the air intake system 1 shown in the exemplary embodiment is used in an internal combustion engine with six cylinders. The air intake system 1 is arranged in a front engine bay of a passenger motor vehicle. The air intake system 1 has a first collecting chamber 2 and a second collecting chamber 3 which are arranged parallel to one another and in the longitudinal direction of the vehicle. An inflow line 4 serves for supplying intake air to the first collecting chamber 2. FIGS. 1 and 2 show only a connecting pipe stub 5 of said inflow line 4. Said connecting pipe stub 5 serves to hold a throttle flap 6 for regulating the intake air supply to the first collecting chamber 2. The throttle flap 6 is shown in FIG. 2 in the position in which it opens the opening of the connecting pipe stub 5. The connecting pipe stub 5 faces toward the front end of the engine bay.

The air intake system 1 has six ram pipes 7. Each ram pipe 7 is formed by a first region 11, which is connected to the first collecting chamber 2 and is guided in a sealed fashion into the second collecting chamber 3 and is guided through said second collecting chamber 3, and by a second region 12. The second region 12 of said ram pipe 7 is arranged outside and is connected to the second collecting chamber 3; said second region 12 preferably forms a part of the inlet duct of the cylinder. Within the second collecting chamber 3, the first regions 11 have sections 8 which are adjustable in their longitudinal direction. When the adjustable sections 8 are in a first position, as shown in FIG. 2, intake air is sucked directly through the first regions of the ram pipes 7 into the second regions 12 of the ram pipes 7 and therefore into the cylinders of the internal combustion engine. When the adjustable sections 8 are in a second position (not shown) in which the adjustable sections 8 are adjusted in the direction of the first collecting chamber 2 and are therefore no longer connected to the second regions 12, intake air is sucked into the cylinders of the internal combustion engine via the then shortened intake pipes 7, and therefore only through the second regions 12.

The air intake system 1 also has an overflow chamber device 10 which is arranged above the first regions 11 of the ram pipes 7 and which connects the two collecting chambers 2 and 3 to one another in terms of flow. The alignment of the overflow chamber device 10 is in the transverse direction of the vehicle, corresponding to the alignment of the ram pipes 7.

In detail, the first collecting chamber 2 and the second collecting chamber 3 have upper, cover-like sections 33. The collecting chambers 2 and 3 and the overflow chamber device 10 are formed as a single-piece molded part. Purely for greater clarity, FIGS. 2 to 3 show the upper sections 33 and the overflow chamber device 10 as a separate unit. The air inlet opening of the overflow chamber device 10 is denoted by the reference symbol 13, and the air outlet opening of the overflow chamber device 10 is denoted by the reference symbol 14.

It can be seen in particular from the illustration of FIGS. 1 and 3 that the overflow chamber device 10 is designed so as to widen in the longitudinal direction of the two collecting chambers 2 and 3; in physical terms, so as to rise rearward with respect to the arrangement of the intake system 1 in a front engine bay of a passenger motor vehicle. Moreover, the overflow chamber device 10 is arranged asymmetrically with respect to an axis of symmetry arranged transversely with respect to the longitudinal extent of the two collecting chambers 2, 3, in particular in the central and rear region of the collecting chambers 2, 3 with respect to the arrangement of the air intake system 1 in a front engine bay of a passenger motor vehicle. Said arrangement of the upper surface 20 is therefore matched to the arrangement of the engine hood of the vehicle which is arranged above and a short distance from said surface 20, which engine hood likewise rises obliquely upward slightly from front to rear. Said arrangement of the overflow chamber device 10 below the engine hood of the vehicle results in optimized pedestrian impact protection.

On account of the described design of the air intake system 1, the first collecting chamber 2 performs the function of a torque collecting chamber, and the second collecting chamber 3 performs the function of a power collecting chamber. When the adjustable sections 8 are in the first position, the ram pipes 7 suck in only the intake air which is then supplied directly to the cylinders of the internal combustion engine. In contrast, in the power position of the internal combustion engine, in which the adjustable sections 8 of the ram pipes 7 are in their second position, the cylinders can suck directly from the overall volume of the second collecting chamber 3 via the second regions 12 of the ram pipes 7, wherein on account of the special design of the air intake system 1 with the additional overflow chamber device 10, intake air passes into the second collecting chamber 3 not only through the first regions 11 of the ram pipes 7 but also via the overflow chamber device 10. On account of the extremely large cross section of the overflow chamber device 10, in the power position of the internal combustion engine, the intake air is sucked in part via the overflow chamber device 10 from the first collecting chamber 2 into the second collecting chamber 3. An additional overflow volume between the torque collecting tank and the power collecting tank is therefore made available for an increased air mass throughput in the power position.

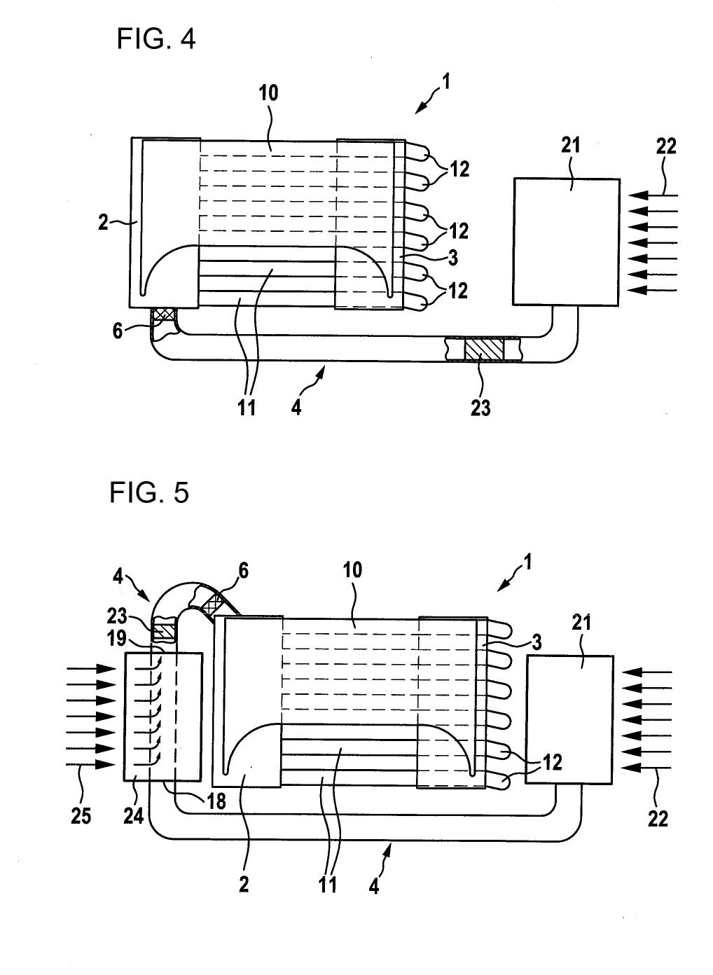

FIG. 4 shows, in a schematic illustration, the air intake system 1 shown in detail in FIGS. 1 to 3. Arranged on that side of the second collecting chamber 3 which faces away from the first air chamber 2 is an air filter 21 into which untreated air enters, as shown by the several arrows 22. From the air filter 21, the inflow line 4 is conducted past the air intake system 1 to the first collecting chamber 2 and the throttle flap 6 situated there. A short distance downstream of the air filter 21, therefore between the air filter 21 and the throttle flap 6, a measuring device 23 is arranged within the inflow line 4, which measuring device 23 determines the air mass flow sucked in through the inflow line 4. Said measuring device is designed for example as a hot film mass sensor.

The modification as per FIG. 5 has two air filters 21 and 24, with the one air filter 21 being arranged corresponding to the design as per FIG. 4, while the other air filter 24 is arranged on that side of the first collecting chamber 2 which faces away from the second collecting chamber 3. As a result of these two air filters 21 and 24 arranged at the sides of the air intake system 1, the installation space in the engine bay of the vehicle can be utilized optimally. The arrows 25 show the entry of the untreated air into the air filter 24. The clean air from the air filter 21 is sucked in through a section of the inflow line 4 which is connected to the clean-air side of the air filter 24. For this purpose, an inlet pipe stub 18 for a connection to the clean-air side of the air filter 21 is provided in the clean-air shell. The clean air of the air filter 24 and the clean air which is introduced into the clean-air connecting pipe stub of said air filter 24 are discharged out of the air filter 24 through the outlet pipe stub 19. Since the clean air flow passing from the air filter 21 passes through the clean-air shell of the air filter 24, a Y-piece for merging the two air flows is made superfluous.

Between the second filter 24 and the first collecting chamber 2, firstly the measuring device 23, and a short distance upstream of the opening of the inflow line 4 into the first collecting chamber 2, the throttle flap 6, are arranged in that section of the inflow line 4 which connects said second filter 24 and first collecting chamber 2. In the modification as per FIG. 5, the inflow line 4 opens out not in the longitudinal direction of the first collecting chamber 2, as in the embodiment of FIG. 4, but rather opens out obliquely into the first collecting chamber 2 in a longitudinal-side end region of the latter. In physical terms, the opening-out takes place in the rear region of the first collecting chamber 2. It would likewise be conceivable for said oblique opening-out to be provided in the front region of the first collecting chamber 2.

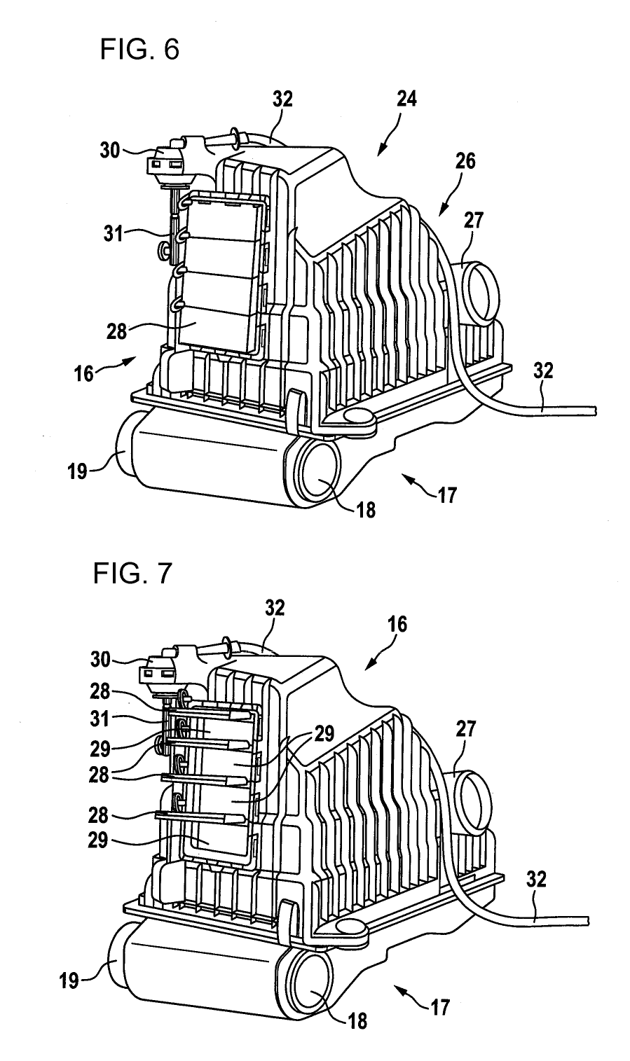

FIGS. 6 and 7 show a physical embodiment of the air filter 24 used in the modification as per FIG. 5. The figures show the housing 26 of the air filter 24, which housing 26 comprises an untreated-air-side housing part 16 and a clean-air-side housing part 17. A non-illustrated filter element which is arranged within the housing 26 is positioned in the region of the parting plane between the two housing parts 16 and 17. Clean air passes through an inlet pipe stub 18 of the housing part 17 from the other air filter 21 into the housing part 17, and leaves the latter through an outlet pipe stub 19 of said housing part 17 to the collecting chamber 2.

The entry of the untreated air into the housing part 16 of the air filter 24 takes place via an outlet pipe (not shown) which is connected to a connecting pipe stub 27 of the housing part 16. In order to be able to pass variable, in particular large air masses through the housing part 16, an additional entry of the untreated air into the housing part 16 of the air filter 24 in the direction of the arrows 25 as per FIG. 5 is created by means of switchable flaps 28 which are assigned to an air inlet opening 29 of the housing part 16. By means of a pressure capsule 30 and an actuating drive 31 which is connected thereto, the flaps 28 can be switched into the “open” or “closed” position. The switching points are freely selectable and can be controlled electronically. The reference symbol 32 denotes a vacuum hose which leads to the pressure capsule 30. The clean air which has passed into the housing part 16 passes over through the filter element into the housing part 17 and leaves the latter through the outlet pipe stub 19.

1. An air intake system of a multi-cylinder internal combustion engine, comprising:
a first collecting chamber and a second collecting chamber;
an inflow line for supplying intake air to said first collecting chamber;
a plurality of ram pipes having first regions connected to said first collecting chamber, projecting through said second collecting chamber, and opening out into second regions disposed outside of and connected to said second collecting chamber;
said first regions of said ram pipes having adjustable sections disposed within said second collecting chamber and movable between a first position and a second position, wherein:
when said adjustable sections of said ram pipes are in the first position, intake air is aspirated directly through said first and second regions of said ram pipes; and
when said adjustable sections of said ram pipes are in the second position, intake air is aspirated into said second collecting chamber and, from there, into said second regions of said ram pipes; and
an additional overflow chamber device disposed to connect said first collecting chamber with said second collecting chamber.

2. The air intake system according to claim 1, wherein the internal combustion engine has six cylinders.

3. The air intake system according to claim 1, wherein a number of said ram pipes corresponds to the number of cylinders of the internal combustion engine.

4. The air intake system according to claim 1, wherein said first collecting chamber and said second collecting chamber are disposed parallel to one another with respect to a longitudinal extent thereof.

5. The air intake system according to claim 4, wherein said ram pipes extend perpendicularly to a longitudinal extent of said first and second collecting chambers.

6. The air intake system according to claim 1, wherein said overflow chamber device is a hood.

7. The air intake system according to claim 1, wherein said first chamber, said second chamber, and said overflow chamber device are integrally formed as a single-piece molded body.

8. The air intake system according to claim 1, wherein said overflow chamber device is configured to widen in a longitudinal direction of said first and second collecting chambers.

9. The air intake system according to claim 8, wherein said overflow chamber device is configured to rise rearwardly with respect to an arrangement of the intake system in a forward engine bay of a passenger motor vehicle.

10. The air intake system according to claim 1, wherein said overflow chamber device is disposed asymmetrically with respect to an axis of symmetry arranged transversely with respect to a longitudinal extent of said first and second collecting chambers.

11. The air intake system according to claim 10, wherein said overflow chamber device is disposed in a central and rear region of said collecting chambers with respect to an arrangement of the intake system in a forward engine bay of a passenger motor vehicle.

12. The air intake system according to claim 1, wherein said inflow line opens out into said first collecting chamber in a longitudinal direction thereof.

13. The air intake system according to claim 1, wherein said inflow line opens out obliquely into said first collecting chamber in a longitudinal end region thereof, on a side of said first collecting chamber facing away from said ram pipes.

14. The air intake system according to claim 1, which comprises a throughflow regulator for said inflow line disposed in a region of said first collecting chamber.

15. The air intake system according to claim 14, wherein said throughflow regulator is a throttle flap.

16. The air intake system according to claim 1, wherein said inflow line has an air filter arranged on a side of said second collecting chamber facing away from said first collecting chamber.

17. The air intake system according to claim 1, wherein said inflow line has two air filters, including a first air filter disposed on a side of said second chamber facing away from said first collecting chamber, and a second air filter disposed on a side of said first collecting chamber facing away from said second collecting chamber.

18. The air intake system according to claim 1, wherein said inflow line has a first air filter and a second air filters, and wherein clean air from said first air filter is aspirated through a section of said inflow line connected to a clean-air side of said second air filter.
